(19) United States
(12) Patent Application Publication
(10) Pub. No.: US 2011/0121137 A1
(43) Pub. Date: May 26, 2011

(54) METHOD AND APPARATUS FOR DIRECTING WASTE AWAY FROM AIRCRAFT

(75) Inventor: Arthur David Sandiford, Valencia, CA (US)

(73) Assignee: ELECTROFILM MANUFACTURING COMPANY LLC, Valencia, CA (US)

(21) Appl. No.: 12/952,650

(22) Filed: Nov. 23, 2010

Related U.S. Application Data
(60) Provisional application No. 61/264,000, filed on Nov. 24, 2009.

(51) Int. Cl. B64D 1/00

(52) U.S. Cl. 244/136

(57) ABSTRACT

A method and apparatus for directing waste away from an aircraft contemplate a fairing having a first end and a second end; a connection flange mounted on the first end of the fairing; a drain pipe extending through the fairing from the first end to the second end; a heating element in the fairing; a vortex redirector attached to the second end of the fairing; and an air splitter and a vortex generator extending outward from the fairing. The vortex redirector and the vortex generator, along with the air splitter, manage airflow to direct waste away from the aircraft. The method may include separating airflow passing over a drain mast assembly by an air splitter; holding airflow near a surface of a fairing by a pair of vortex generators; and redirecting airflow upwards by a vortex redirector. The redirecting forces airflow into the underside of the air splitter, while increasing velocity of the airflow above the air splitter. The method further contemplates delaying a wake separation point of airflow over the drain mast assembly by the vortex redirector to further accelerate the airflow. This precludes waste from attaching to the fairing and suspends the waste in airflow beneath the drain mast assembly.

### CROSS REFERENCE TO RELATED APPLICATIONS

The present application claims the benefit of U.S. Provisional Application No. 61/264,000, filed on Nov. 24, 2009, which is incorporated herein by reference in its entirety.

### BACKGROUND

The present application generally relates to a method and apparatus for directing waste away from an aircraft. The present application more particularly relates to a method and apparatus for reducing impingement caused by draining waste from the aircraft by directing the airflow and waste away from the aircraft.

An aircraft is conventionally equipped with at least one apparatus for draining waste from the aircraft during flight. The mechanism for draining waste is known as a drain mast. The drain mast may be provided either on the underside or on the belly of the aircraft. Waste typically exits the drain mast using the force of gravity or using pressure.

In conventional drain mast configurations, aerodynamic back flow of air as well as boundary layer conditions result in waste impinging on the drain mast, the aircraft fuselage or both. Typically, surface heaters are applied to the drain mast fairing of the aircraft to melt ice that builds up on the drain mast, to mask impingement and to prevent the formation of larger ice structures from further attaching to the drain mast. However, the impingement of the waste water on the fuselage is not decreased as a result of the surface heaters warming the drain mast fairing. Instead, water that is dispersed will be caught in the recirculation back draft, causing it to attach to the drain mast. Additionally, ice may begin to form on the fuselage behind the drain mast. The ice may continue to grow due to a low pressure area adjacent to the fuselage, which draws in fluids that are suspended in the wake of the drain mast passing through the air. The ice will begin to affect the aerodynamic efficiency of the drain mast and the fuselage, thereby affecting the movement of the aircraft.

### SUMMARY

The present application relates to an apparatus for directing waste away from an aircraft. The apparatus includes a fairing having a first end and a second end; a connection flange mounted on the first end of the fairing; a drain pipe extending through the fairing from the first end to the second end; a heating element in the fairing; a vortex redirector attached to the second end of the fairing; and an air splitter and a vortex generator extending outwards from the fairing, wherein the vortex redirector and the vortex generator along with the air splitter manage airflow to direct waste away from the aircraft.

The present application also relates to a drain mast assembly for directing waste away from an aircraft. The drain mast assembly includes a fairing comprising a first end and a second end; a connection flange mounted on the first end of the fairing for attachment to an aircraft fuselage; a drain pipe extending through the fairing to drain waste; a vortex redirector mounted to the fairing; and a pair of air splitters and a pair of vortex generators extending outwards from the fairing, wherein the vortex redirector and the vortex generators along with the air splitters direct airflow such that waste draining from the aircraft is precluded from contacting the fuselage.

The present application further relates to a method for directing waste away from a drain mast assembly extending downward from an aircraft fuselage. The method includes separating airflow passing over a drain mast assembly by an air splitter; holding airflow near a surface of a fairing by a pair of vortex generators; redirecting airflow upwards by a vortex redirector, the redirecting forces airflow into the underside of the air splitter, while increasing velocity of the airflow above the air splitter; and delaying a wake separation point of airflow over the drain mast assembly by the vortex redirector to further accelerate the airflow precluding waste from attaching to the fairing and suspending the waste in airflow beneath the drain mast assembly.

### BRIEF DESCRIPTION OF THE DRAWINGS

The present disclosure will become more fully understood from the following detailed description, taken in conjunction with the accompanying figures, wherein like reference numerals refer to like elements, in which:

FIG. 1 is a schematic view of the side of a drain mast assembly directing waste, according to an embodiment of the present disclosure;

FIG. 2 is a schematic view of the front of the drain mast assembly of FIG. 1;

FIG. 3 is a schematic view of the bottom of a drain mast assembly of FIG. 1;

FIG. 4 is an enlarged, partial front view of the drain mast assembly of FIG. 1, showing the vortex redirector; and

FIG. 5 is a diagrammatic view, illustrating a method for directing waste away from the drain mast assembly, according to an embodiment of the present disclosure.

### DETAILED DESCRIPTION

Before turning to the figures, which illustrate several embodiments in detail, it should be understood that the application is not limited to the details or methodology set forth in the description or illustrated in the figures. It should also be understood that the terminology is for the purpose of description only and should not be regarded as limiting.

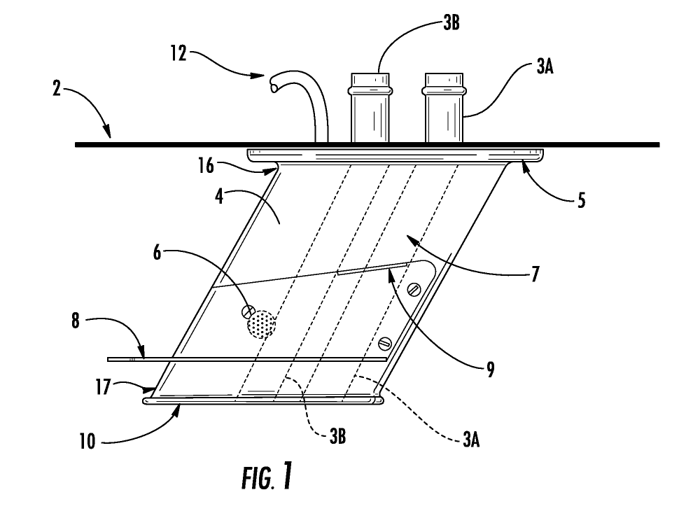

FIG. 1 is a schematic side view of a drain mast assembly for directing waste away from an aircraft, according to an embodiment of the present disclosure. As illustrated, a fairing 4 has a first end 16 and a second end 17. A connection flange 5 is mounted on the first end 16 of the fairing 4. A pair of drain pipes 3A and 3B extend through the fairing 4 from the first end 16 to the second end 17. Although two drain pipes are illustrated, it will be understood that only a single drain pipe or a greater number of drain pipes may be used. The upper ends of the pipes 3A and 3B will be connected to a waste water system of an aircraft. A heating element 7 is positioned in the fairing 4. A vortex redirector 10 is attached to the second end 17 of the fairing 4. An air splitter 8 and a vortex generator 9 extend outward from the fairing 4. The vortex redirector 10 and the vortex generator 9, along with the air splitter 8, manage airflow to direct waste away from the aircraft. The fairing 4 may also have a temperature sensor 6. The connection flange 5 may also include a seal for sealing the connection flange 5 to the aircraft fuselage 2. The apparatus may also include a provision for power and sensor leads 12.

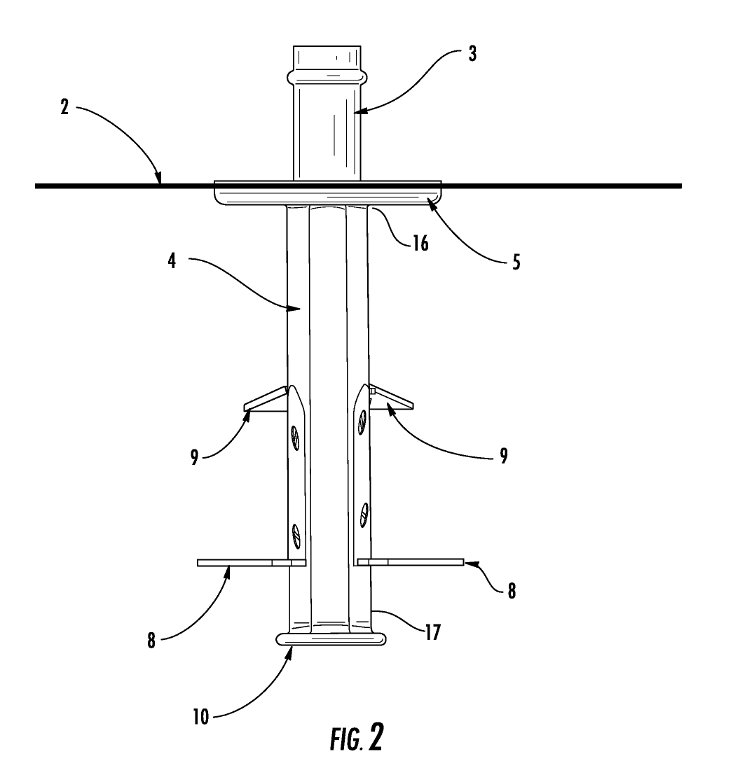

FIG. 2 is a schematic view of the front of the drain mast assembly of FIG. 1. The drain mast assembly may include a fairing 4 with a heating element and a temperature sensor. The drain mast may have the air splitters 8 mounted between the connection flange 5 and the second end 17 of the fairing 4. The vortex generators 9 may be mounted between the connection flange 5 and the air splitters 8.

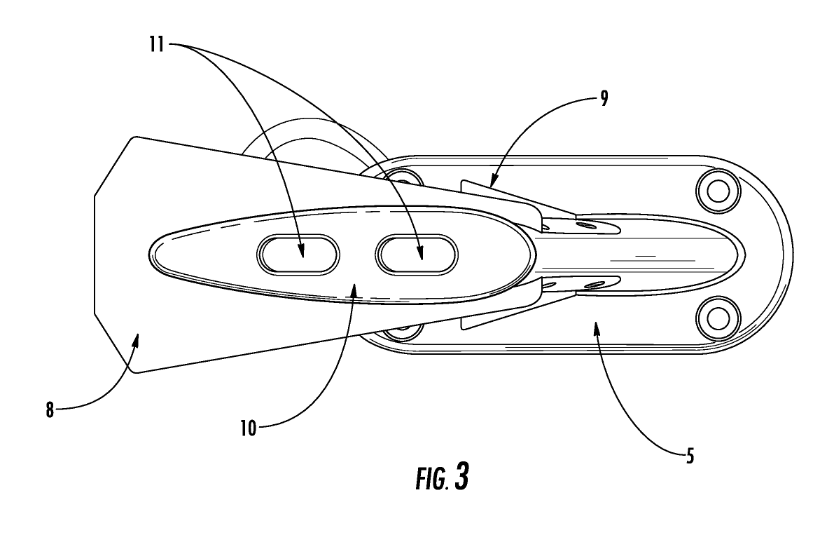

Referring to FIG. 3, the drain mast assembly may include water drain outlets 11, which communicate with drain pipes 3A and 3B. These can be shaped to reduce frontal area by elongation or custom design. This narrows the waste water dispersion pattern. The discharge from the water drain outlets 11 can exit the drain mast assembly by gravity or by pressure. The width of the water drain outlets 11 can be determined by the largest waste obstruction reasonably expected to pass through the drain mast assembly.

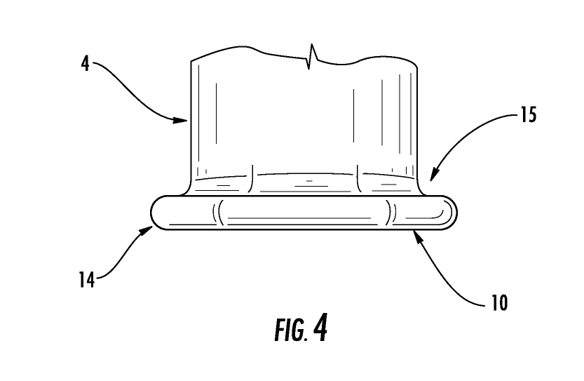

Referring to FIG. 4, the vortex redirector 10 may have a radial perimeter forming a soft edge vortex 14. The vortex redirector 10 may also have a return curve 15 extending into the fairing 4. This allows the vortex redirector 10 to effectively delay the wake separation point of the airflow, ultimately preventing the waste from impinging on the aircraft.

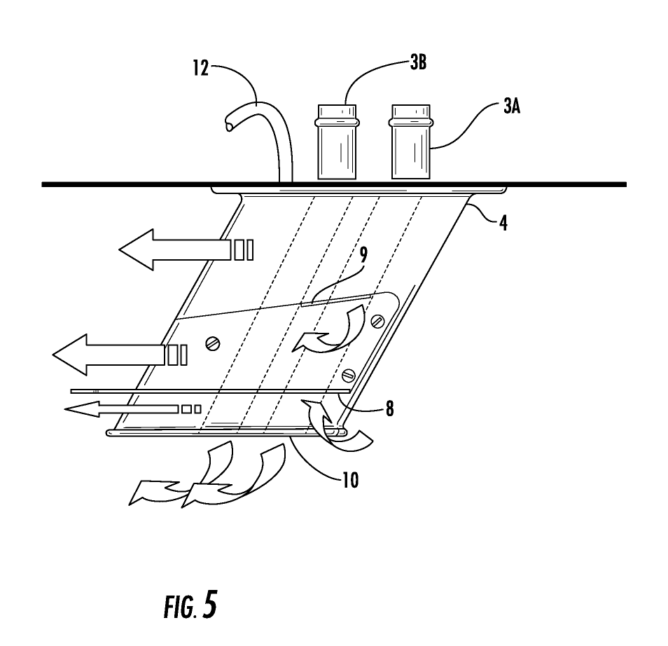

FIG. 5 is a schematic view illustrating the method by which waste is directed away from a drain mast assembly extending downward from an aircraft fuselage, according to an embodiment of the present disclosure. This method contemplates separating airflow passing over the drain mast assembly by an air splitter 8. The airflow is held near a surface of fairing 4 by a pair of vortex generators 9. Airflow is also redirected upward by a vortex redirector 10. The redirected air is forced into the underside of the air splitter 8, while increasing the velocity of the airflow above the air splitter 8. This method delays the wake separation point of airflow over the drain mast assembly by means of the vortex redirector 10 to accelerate the airflow further, precluding waste from attaching to the fairing 4, and suspending the waste in airflow beneath the drain mast assembly.

While the present disclosure has been particularly shown and described with reference to specific embodiments, it should be understood by those skilled in the art that various changes in form and detail may be made therein without departing from the spirit and scope of the disclosure as defined by the appended claims.

What is claimed is:

1. An apparatus for directing waste away from an aircraft comprising:
a fairing having a first end and a second end;
a connection flange mounted on the first end of the fairing;
a drain pipe extending through the fairing from the first end to the second end;
a heating element in the fairing;
a vortex redirector attached to the second end of the fairing; and
an air splitter and a vortex generator extending outward from the fairing, wherein the vortex redirector and the vortex generator along with the air splitter manage airflow to direct waste away from the aircraft.

2. An apparatus of claim 1, further comprising a temperature sensor in the fairing.

3. An apparatus of claim 1, wherein the connection flange includes a seal for sealing the connection flange to an aircraft fuselage.

4. An apparatus of claim 1, further comprising power or sensor leads.

5. An aircraft comprising the apparatus of claim 1.

6. A drain mast assembly for directing waste away from an aircraft, the drain-mast assembly comprising:
a fairing comprising a first end and a second end;
a connection flange mounted on the first end of the fairing for attachment to an aircraft fuselage;
a drain pipe extending through the fairing to drain waste;
a heating element and a temperature sensor in the fairing;
a vortex redirector mounted to the fairing; and
a pair of air splitters and a pair of vortex generators extending outward from the drain mast assembly, wherein the vortex redirector and the vortex generators along with the air splitters direct airflow such that waste draining from the aircraft is precluded from contacting the fuselage.

7. The drain mast assembly of claim 6, wherein the air splitters are mounted between the connection flange and the second end of the fairing.

8. The drain mast assembly of claim 6, wherein the connection flange includes a seal for sealing against air leakage between the fuselage and the connection flange.

9. The drain mast assembly of claim 6, wherein the vortex generators are mounted between the connection flange and the air splitter.

10. The drain mast assembly of claim 6 further comprising water drain outlets.

11. The drain mast assembly of claim 6, wherein the vortex redirector defines a radial perimeter forming a soft edge vortex.

12. The drain mast assembly of claim 11, wherein the vortex redirector further defines a return curve extending into the fairing.

13. An aircraft comprising the apparatus of claim 6.

14. A method for directing waste away from a drain mast assembly extending downward from an aircraft fuselage, the method comprising:
separating airflow passing over a drain mast assembly by an air splitter;
holding airflow near a surface of a fairing by a pair of vortex generators;
redirecting airflow upwards by a vortex redirector, the redirecting forces airflow into the underside of the air splitter, while increasing velocity of the airflow above the air splitter;
and delaying a wake separation point of airflow over the drain mast assembly by the vortex redirector to further accelerate the airflow precluding waste from attaching to the fairing and suspending the waste in airflow beneath the drain mast assembly.
